(19) United States
(12) Patent Application Publication
(10) Pub. No.: US 2023/0229640 A1
(43) Pub. Date: Jul. 20, 2023

(54) COLLABORATIVE DATA SCHEMA MANAGEMENT FOR FEDERATED LEARNING

(71) Applicant: VMware, Inc., Palo Alto, CA (US)

(72) Inventors: Layne Lin Peng, Shanghai (CN); Hai Ning Zhang, Beijing (CN); Jia Hao Chen, Shenzhen (CN); Fangchi Wang, Beijing (CN)

(21) Appl. No.: 17/580,574

(22) Filed: Jan. 20, 2022

Related U.S. Application Data
(63) Continuation of application No. PCT/CN2021/137855, filed on Dec. 14, 2021.

(30) Foreign Application Priority Data
Dec. 14, 2021 (WO) PCT/CN2021/137855

(51) Int. Cl. G06F 16/21; G06N 20/00; G06F 16/27

(52) U.S. Cl. CPC G06F 16/211; G06N 20/00; G06F 16/27

(57) ABSTRACT

A collaborative data schema management system for federated learning (i.e., federated data manager (FDM)) is provided. Among other things, FDM enables the members of a federated learning alliance to (1) propose data schemas for use by the alliance, (2) identify and bind local datasets to proposed schemas, (3) create, based on the proposed schemas, training datasets for addressing various ML tasks, and (4) control, for each training dataset, which of the local datasets bound to that training dataset (and thus, which alliance members) will actually participate in the training of a particular ML model. FDM enables these features while ensuring that the contents of the members' local datasets remain hidden from each other, thereby preserving the privacy of that data.

### CROSS-REFERENCES TO RELATED APPLICATIONS

The present application is a continuation of International Application No. PCT/CN2021/137855 filed Dec. 14, 2021, entitled “Collaborative Data Schema Management for Federated Learning,” the entire contents of which are incorporated herein by reference for all purposes.

### BACKGROUND

Unless otherwise indicated, the subject matter described in this section is not prior art to the claims of the present application and is not admitted as being prior art by inclusion in this section.

Federated learning is a machine learning (ML) paradigm that enables multiple parties to jointly train an ML model on training data that is distributed across the parties while keeping the data samples local to each party secret/private. For example, consider a scenario in which three organizations O₁, O₂, and O₃ hold local datasets D₁, D₂, and D₃ respectively and would like to train a global ML model M on the aggregation of D₁, D₂, and D₃. Federated learning provides protocols that allows O₁, O₂, and O₃ to achieve this without revealing the contents of D₁, D₂, and D₃ to each other or to any other entity.

There are two types of federated learning that are distinguished by the structure of the local datasets held by the parties: sample-partitioned (also known as horizontal or homogenous) federated learning and feature-partitioned (also known as vertical or heterogeneous) federated learning. With sample-partitioned federated learning, the parties' local datasets share a consistent feature set (i.e., data schema) and contain different data samples pertaining to that consistent data schema. For instance, in the example above with organizations O₁, O₂, and O₃, datasets D₁, D₂, and D₃ may share a data schema comprising features [SSN, name, age] and each dataset may include data samples for different individuals with appropriate values for these features (e.g., [111-11-1111, “Bob Smith”, 39], [222-22-2222, “Ann Jones”, 54], etc.).

With feature-partitioned federated learning, the parties' local datasets include different features and thus have different data schemas, but also include at least one common feature can that be used to associate (i.e., join) the data samples across the local datasets and thereby tie those data samples together for training purposes. For instance, in the example above dataset D₁ may include the data schema [SSN, name, age], dataset D₂ may include the data schema [SSN, height, weight, eye color, hair color], and dataset D₃ may include the data schema [SSN, credit score, household income]. In this case, during the training of global ML model M, the data samples in D₁, D₂, and D₃ can be joined using common feature SSN in order to create composite data samples that include all of the features of D₁, D₂, and D₃ for each unique SSN value.

A significant challenge with implementing federated learning in the real world is that, due to its decentralized nature and the need to maintain data privacy, it is difficult for potential parties to discover/understand what types of training data are available across an alliance of such entities and to manage the use/contribution of their respective local datasets for specific training tasks. This is particularly problematic for feature-partitioned federated learning because the data schemas across parties will differ and thus one party will not know (and cannot easily infer) the features that may be present in the local datasets of other parties.

### BRIEF DESCRIPTION OF THE DRAWINGS

FIG. 1 depicts an example environment according to certain embodiments.

FIG. 2 depicts a high-level data management workflow according to certain embodiments.

FIG. 3 depicts a data schema object creation workflow according to certain embodiments.

FIG. 4 depicts a schema data binding creation workflow according to certain embodiments.

FIG. 5 depicts a training dataset object and training configuration object creation workflow according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

### 1. Overview

Embodiments of the present disclosure are directed to a collaborative data schema management system for federated learning, referred to herein as “federated data manager” (FDM). Among other things, FDM enables the members of a federated learning alliance (e.g., organizations, data scientists, etc.) to (1) propose data schemas for use by the alliance, (2) identify and bind local datasets to proposed schemas, (3) create, based on the proposed schemas, training datasets for addressing various ML tasks, and (4) control, for each training dataset, which of the local datasets bound to that training dataset (and thus, which alliance members) will actually participate in the training of a particular ML model. Significantly, FDM enables these features while ensuring that the contents (i.e., data samples) of the members' local datasets remain hidden from each other, thereby preserving the privacy of that data.

### 2. Example Environment and High-Level Workflow

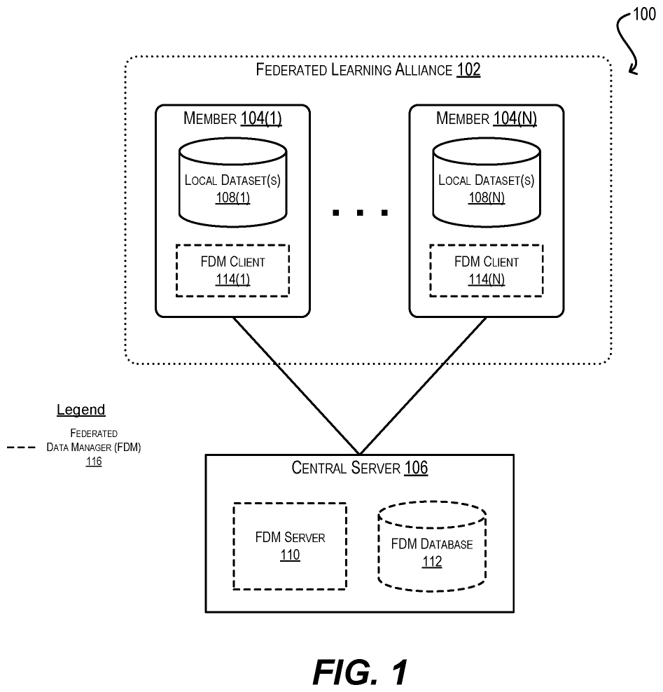

FIG. 1 depicts a simplified representation of an example environment 100 and the implementation of FDM within this environment according to certain embodiments. As shown, environment 100 includes a federated learning alliance 102 comprising a plurality of members 104(1)-(N) that are communicatively coupled with a central server 106. Each alliance member 104 (which may be an enterprise, organization, individual, etc.) is an entity that maintains one or more local datasets 108 (i.e., datasets that reside on the computing premises of that member) and has agreed to collaborate with other alliance members for federated learning purposes. For example, in one set of embodiments, alliance members 104(1)-(N) may be companies in the same industry with local datasets that have the same or substantially similar data schemas (e.g., airline companies with similar passenger databases). In these embodiments, alliance members 104(1)-(N) may collaborate with each other to train ML models via sample-partitioned federated learning, such that each member contributes local training data that conform to a common data schema.

In other embodiments, alliance members 104(1)-(N) may be companies in different industries with local datasets that have different data schemas, but some degree of feature overlap. For example, alliance member 104(1) may be an e-commerce company with a local database storing the purchase histories of its customers and alliance member 104(2) may be a bank with a local database storing the financial records (e.g., account balances, etc.) of those same (and other) customers. In these embodiments, alliance members 104(1)-(N) may collaborate with each other to train ML models via feature-partitioned federated learning, such that each member contributes local training data that conform to different data schemas but can be join together via at least one common feature (e.g., customer identifier (ID)).

As noted in the Background section, a significant challenge with implementing federated learning across a federation/alliance like alliance 102 of FIG. 1 is that it is difficult for alliance members 104(1)-(N) to discover, track, and manage the local training data that is available at each member. This is particularly true for the use case of feature-partitioned federated learning, where the data schemas across alliance members 104(1)-(N) will differ. For instance, how can each alliance member determine what types of data are available in the local datasets of other alliance members in order to propose training datasets for solving/addressing ML tasks, while preventing data leakage? Further, how can the alliance members associate their local datasets with such proposed training datasets and control whether or not they will participate in particular training runs?

To address the foregoing and other similar issues, environment 100 implements a novel data schema management system for federated learning—shown as federated data manager (FDM) 116—that is composed of an FDM server 110 and FDM database 112 running on central server 106 and an FDM client 114 running on the local computer system(s) of each alliance member 104. Generally speaking, FDM 116 enables alliance members 104(1)-(N) to collaboratively propose data schemas (in the form of “data schema objects”) for use by federated learning alliance 102; identify and bind (in the form of “schema data bindings”) their local datasets to the proposed schemas; create/propose, based on the proposed schemas, training datasets (in the form of “training dataset objects”) for addressing various ML tasks; and control which local datasets/alliance members actually participate in specific training runs via the training dataset objects. This is all achieved while keeping the alliance members' local datasets at their respective local premises, thereby preserving data privacy. Accordingly, FDM 116 solves the data management challenges of federated learning (and in particular, feature-partitioned federated learning) in a structured and secure fashion.

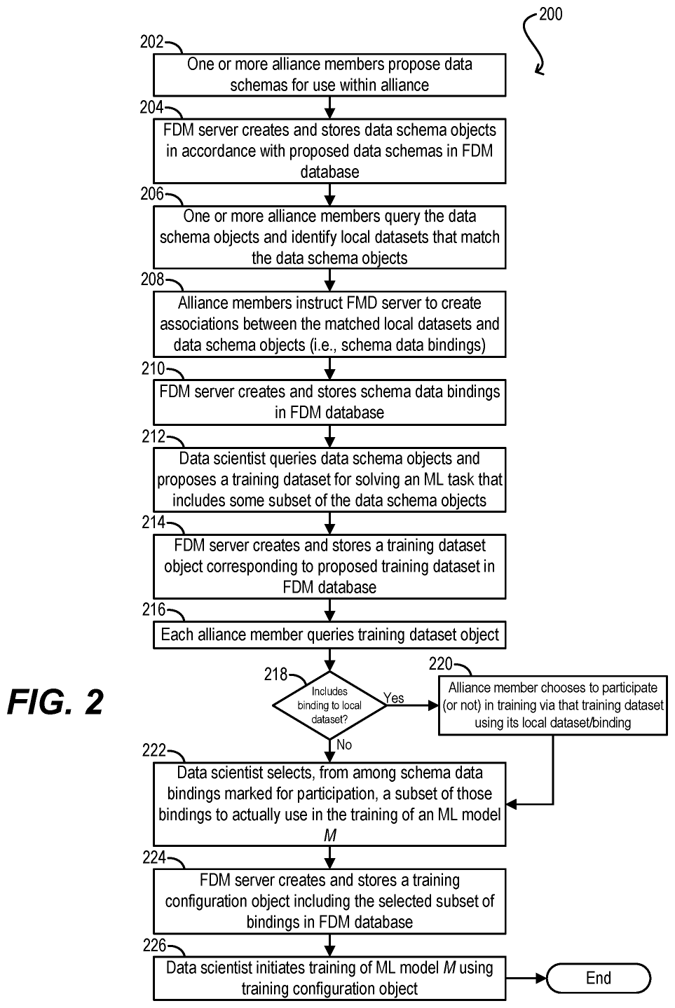

FIG. 2 depicts a high-level data management workflow 200 between alliance members 104(1)-(N) that is enabled by FDM 116 according to certain embodiments. Although not explicitly stated, it is assumed that the steps performed by each alliance member 104 in workflow 200 are executed via its respective FDM client 114.

Starting with steps 202 and 204, one or more alliance members 104(1)-(N) can propose data schemas for use within federated learning alliance 102 and FDM server 110 can create and store data schema objects corresponding to the proposed data schemas in FDM database 112. As mentioned previously, a data schema is a set of features (also known as attributes or columns) that represents the types of data that are part of each data sample in a dataset. For instance, an example data schema S₁ may include the features [SSN, name, age] where SSN and name are strings and age is an integer.

At step 206, one or more alliance members 104(1)-(N) can query the data schema objects that have been proposed/created and can identify local datasets that match (i.e., include the same or similar features as) those data schema objects. The alliance members can then instruct FDM server 110 to create associations (i.e., schema data bindings) between the matching (local dataset, data schema object) pairs (step 208). In this way, the alliance members can preliminarily “contribute” their local datasets to the proposed data schemas for federated learning purposes. In response, FDM server 110 can create and store the schema data bindings in FDM database 112 (step 210). Note that one data schema object can be bound to multiple local datasets (either from the same or different alliance members), which means that the data schema object can have multiple potential data sources.

For example, an alliance member 104(1) may query data schema S₁ noted above, determine that S₁ has the same features as a local dataset D₁, and instruct FDM server 110 to create a first schema data binding B₁ for S₁ that binds it to D₁. Similarly, an alliance member 104(2) may query data schema S₁, determine that S₁ has the same features as a local dataset D₂, and instruct FDM server 110 to create a second schema data binding B₂ for S₁ that binds it to D₂ . Significantly, each schema data binding created and stored at step 212 can include a reference to its corresponding local dataset (e.g., connection endpoint information), but not the actual content (i.e., data samples) of that local dataset. This ensures that those data samples remain on the premises of each member 104 and thus is not revealed to central server 106 or the other alliance members.

At step 212, a data scientist associated with federated learning alliance 102 can query the data schema objects in FDM database 112 and propose a training dataset for solving an ML task that includes some subset of the data schema objects. As used herein, this “data scientist” is any individual or entity that can identify ML tasks and propose training datasets for addressing the identified tasks. For example, in one set of embodiments the data scientist may be a person (or group of people) affiliated with federated learning alliance 102, such as employees of one or more alliance members. In another set of embodiments, this data scientist may comprise one or more automated programs/agents.

If the ML task identified by the data scientist involves training an ML model via sample-partitioned federated learning, this proposed training dataset can include a reference to a single data schema object which comprises the feature set to be included in the training dataset. Alternatively, if the ML task involves training of an ML model via feature-partitioned federated learning, this proposed training dataset can include references to multiple data schema objects, as well as a “join” feature/column that is common to all of the data schema objects and is intended to join those data schemas together. At step 214, FDM server 110 can create and store a training dataset object corresponding to the proposed training dataset in FDM database 112.

Each alliance member 104 can thereafter query the training dataset object (step 216) and check whether it has a local dataset bound to a data schema object in the training dataset object via a previously-created schema data binding (step 218). If the answer is yes, the alliance member can choose to participate (or not participate) in the training of an ML model using that training dataset object with its local dataset (step 220). If the alliance member does choose to participate, FDM server 110 can update the corresponding schema data binding in FDM database 112 with an appropriate flag/indicator (e.g., a participateInDataset flag) (not shown).

Once the alliance members have chosen their participation preferences with respect to the training dataset object, the data scientist that originally proposed the training dataset can select, from among the schema data bindings with the participateInDataset flag set to true, a subset of those schema data bindings to actually use (and thus participate) in the training of a particular ML model M via federated learning (step 222). For example, if the training dataset object include a reference to a data schema object S₁ and S₁ has two different schema data bindings B₁ and B₂ with participateInDataset=true (indicating that the alliance members owning B₁ and B₂ have chosen to participate with these bindings), the data scientist can select B₁ alone, B₂ alone, or both B₁ and B₂ for use in training ML model M. In response, FDM server 110 can create and store a training configuration object in FDM database 112 that includes references to the training dataset object and the schema data bindings selected at step 222 (step 224).

Finally, the data scientist or some other entity can initiate training of the specified ML model M using the training configuration object (step 226) and workflow 200 can end.

The remaining sections of this disclosure provide additional details for implementing certain portions of high-level workflow 200 according to various embodiments, such as application programming interface (API) invocations and other actions that may be performed by FDM clients 114(1)-(N) and FDM server 110 for creating data schema objects, schema data bindings, training dataset objects, and training configuration objects. It should be appreciated that FIGS. 1 and 2 are illustrative and not intended to limit embodiments of the present disclosure. For example, although workflow 200 assumes that the data scientist proposes a training dataset based on previously-created data schemas at step 212, in alternative embodiments the data scientist may propose the training dataset before any data schemas have been proposed (and thus, before any data schema objects exist FDM database 112). In these embodiments, the data scientist may simultaneously propose one or more data schemas that are desired for the proposed training dataset, or the alliance members can propose data schemas that they believe are appropriate for the proposed training dataset. The alliance members can then contribute local datasets that match the proposed data schemas via the creation of schema data bindings. One of ordinary skill in the art will recognize other variations, modifications, and alternatives.

### 3. Data Schema Object Creation

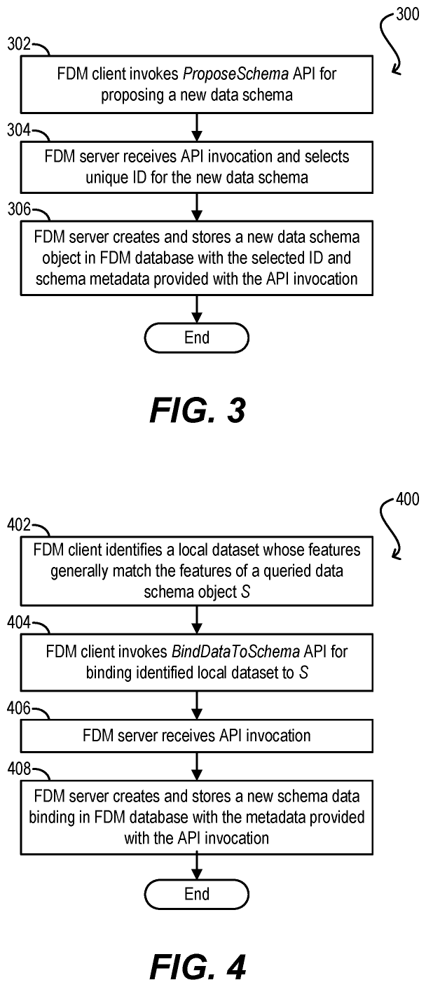

FIG. 3 depicts a workflow 300 that details the processing that may be performed by FDM server 110 and the FDM client of an alliance member 104 or affiliated data scientist for creating a data schema object according to certain embodiments.

Starting with step 302, the FDM client can invoke an API exposed by the FDM server for proposing a new data schema (e.g., ProposeSchema( )) for use within federated alliance 102. In one set of embodiments, this ProposeSchema API can take as input the following parameters:
1. A data schema description; and
2. a set of features, each feature entry including a feature name, a feature data type (e.g., string, integer, float, etc.) and a feature description

At step 304, the FDM server can receive the API invocation and can select a unique ID for the proposed data schema. FDM server can then create and store a new data schema object in FDM database 112 with the selected ID and the schema metadata provided with the API invocation (step 306).

### 4. Schema Data Binding Creation

FIG. 4 depicts a workflow 400 that details the processing that may be performed by FDM server 110 and the FDM client of an alliance member 104 for creating a schema data binding for an existing data schema object S according to certain embodiments. Workflow 400 assumes that the FDM client has queried data schema object S from FDM database 112 via an appropriate query API.

Starting with step 402, the FDM client can identify a local dataset of the alliance member whose features generally match the features of data schema object S (e.g., include the same or similar/compatible feature names/descriptions and data types). For example, the identified local dataset can include a feature set that is identical to, or is a superset of, the feature set of S.

At step 404, the FDM client can invoke an API exposed by the FDM server for binding the identified local dataset to data schema object S (e.g., BindDataToSchema( )). In one set of embodiments, this BindDataToSchema API can take as input the following parameters:
1. An ID of the alliance member;
2. an ID of the local dataset;
3. an ID of data schema object S; and
4. connection information for connecting to/accessing the local dataset (e.g., cluster endpoint, URL, etc.)

At step 406, the FDM server can receive the API invocation. FDM server can then create and store a new schema data binding in FDM database 112 with the metadata provided with the API invocation (step 506). In certain embodiments, the created schema data binding can also include other fields, such as the participateInDataset flag mentioned previously (step 408).

### 5. Training Dataset Object and Training Configuration Object Creation

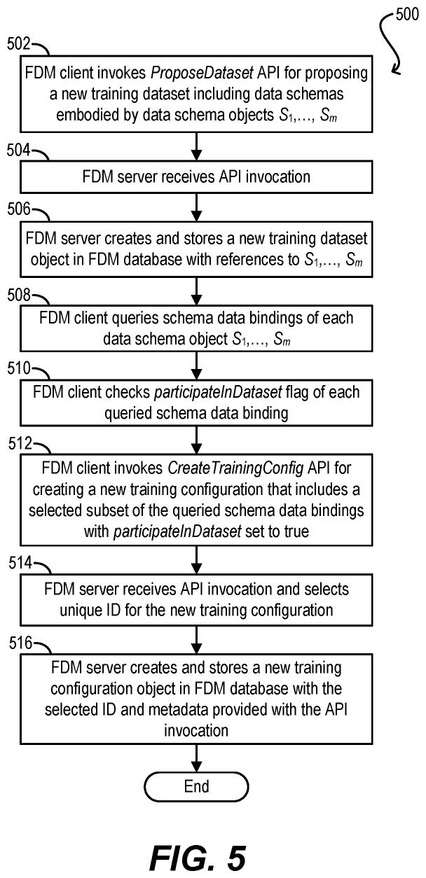

FIG. 5 depicts a workflow 500 that details the processing that may be performed by FDM server 110 and the FDM client of an alliance member 104 or an affiliated data scientist for creating a training dataset object based on one or more existing data schema objects [S₁, . . . , Sₘ] and a corresponding training configuration object according to certain embodiments. Workflow 500 assumes that the FDM client has queried data schema objects [S₁, . . . , Sₘ] from FDM database 112 via an appropriate query API.

Starting with step 502, the FDM client can invoke an API exposed by the FDM server for proposing a new training dataset that includes the data schemas embodied by [S₁, . . . , Sₘ] (e.g., ProposeDataset( )) for use within federated alliance 102. In one set of embodiments, this ProposeDataset API can take as input the following parameters:
1. A training dataset description;
2. IDs of data schema objects [S₁, . . . , Sₘ];
3. a flag indicating whether the training dataset includes heterogenous data schemas (i.e., for feature-partitioned federated learning);
4. if the training dataset is intended to train a supervised ML model, the name of the label feature/column of the training dataset; and
5. if the training dataset includes heterogenous data schemas, the name of the join feature/column of the training dataset

At step 504, the FDM server can receive the API invocation. FDM server can then create and store a new training dataset object T in FDM database 112 with the metadata provided with the API invocation (step 506).

At step 508, the FDM client can query, from the FDM server, the schema data bindings associated with each data schema object [S₁, . . . , Sₘ] in training dataset object T. The FDM client can further check the participateInDataset flag of each queried schema data binding to determine whether the alliance member that owns the schema data binding has agreed to participate in federated learning using T (step 510).

Upon checking the participateInDataset flags, the FDM client can invoke an API exposed by the FDM server for creating a new training configuration that includes a selected subset of the schema data bindings with participateInDataset=true (e.g., CreateTrainingConfig( )) (step 512). This selected subset comprises schema data bindings that the owner of the FDM client (e.g., a data scientist) has determined should be used in the training of a particular ML model M. In one set of embodiments, the CreateTrainingConfig API can take as input the following parameters:
1. Training dataset object T; and
2. IDs of the selected subset of schema data bindings

At step 514, the FDM server can receive the API invocation and can select a unique ID for the training configuration. Finally, FDM server can create and store a new training configuration object in FDM database 112 with the selected ID and the metadata provided with the API invocation (step 516). Although not shown, once the training configuration object is created, it can be used to initiate training of a specified ML model. As part of this training process, the schema data bindings that are referenced within the training configuration object can be used to automatically identify the alliance members and corresponding local datasets that will participate in the training.

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
receiving, by a computer system from a first subset of members of a federated learning alliance, first metadata pertaining to one or more proposed data schemas;
creating, by the computer system, one or more data schema objects in a central database in accordance with the first metadata;
receiving, by the computer system from a second subset of members of the federated learning alliance, second metadata pertaining to one or more associations between local datasets of the second subset of members and the one or more data schema objects;
creating, by the computer system, one or more schema data bindings in the central database in accordance with the second metadata;
receiving, by the computer system from an individual or entity associated with the federated learning alliance, third metadata pertaining to a proposed training dataset for solving a machine learning task, the third metadata specifying the one or more data schema objects;
creating, by the computer system, a training dataset object in the central database in accordance with the third metadata; and
initiating, by the computer system based on the training dataset object, training of a machine learning model via federated learning, wherein the training is executed by at least a portion of the second subset of members using their respective local datasets.

2. The method of claim 1 wherein the one or more schema data bindings include connection information for connecting to the local datasets but do not include data samples of the local datasets.

3. The method of claim 1 wherein the one or more proposed data schemas comprise heterogenous data schemas with different feature sets, but at least one common feature.

4. The method of claim 3 wherein the third metadata includes an identification of the at least one common feature as a join column for the training dataset.

5. The method of claim 1 further comprising, prior to initiating the training of the machine learning model:
receiving, from each of the second subset of members, an indication of whether said each member wishes to participate in the training using its local dataset; and
marking, based on the received indications, a subset of the one or more schema data bindings as being available for the training.

6. The method of claim 5 further comprising, prior to initiating the training of the machine learning model:
receiving, from the individual or entity, a selected portion of the subset of the one or more scheme data bindings that will participate in the training; and
creating a training configuration object in the central database that specifies the selected portion.

7. The method of claim 6 wherein the portion of the second subset of members that execute the training of the machine learning model are members with local datasets included in the selected portion of the subset of the one or more scheme data bindings.

8. A non-transitory computer readable storage medium having stored thereon program code executable by a computer system, the program code causing the computer system to execute a method comprising:
receiving, from a first subset of members of a federated learning alliance, first metadata pertaining to one or more proposed data schemas;
creating one or more data schema objects in a central database in accordance with the first metadata;
receiving, from a second subset of members of the federated learning alliance, second metadata pertaining to one or more associations between local datasets of the second subset of members and the one or more data schema objects;
creating one or more schema data bindings in the central database in accordance with the second metadata;
receiving, from an individual or entity associated with the federated learning alliance, third metadata pertaining to a proposed training dataset for solving a machine learning task, the third metadata specifying the one or more data schema objects;
creating a training dataset object in the central database in accordance with the third metadata; and
initiating, based on the training dataset object, training of a machine learning model via federated learning, wherein the training is executed by at least a portion of the second subset of members using their respective local datasets.

9. The non-transitory computer readable storage medium of claim 8 wherein the one or more schema data bindings include connection information for connecting to the local datasets but do not include data samples of the local datasets.

10. The non-transitory computer readable storage medium of claim 8 wherein the one or more proposed data schemas comprise heterogenous data schemas with different feature sets, but at least one common feature.

11. The non-transitory computer readable storage medium of claim 10 wherein the third metadata includes an identification of the at least one common feature as a join column for the training dataset.

12. The non-transitory computer readable storage medium of claim 8 wherein the method further comprises, prior to initiating the training of the machine learning model:
receiving, from each of the second subset of members, an indication of whether said each member wishes to participate in the training using its local dataset; and
marking, based on the received indications, a subset of the one or more schema data bindings as being available for the training.

13. The non-transitory computer readable storage medium of claim 12 wherein the method further comprises, prior to initiating the training of the machine learning model:
receiving, from the individual or entity, a selected portion of the subset of the one or more scheme data bindings that will participate in the training; and
creating a training configuration object in the central database that specifies the selected portion.

14. The non-transitory computer readable storage medium of claim 13 wherein the portion of the second subset of members that execute the training of the machine learning model are members with local datasets included in the selected portion of the subset of the one or more scheme data bindings.

15. A computer system comprising:
a processor; and
a non-transitory computer readable medium having stored thereon program code that, when executed by the processor, causes the processor to:
receive, from a first subset of members of a federated learning alliance, first metadata pertaining to one or more proposed data schemas;
create one or more data schema objects in a central database in accordance with the first metadata;
receive, from a second subset of members of the federated learning alliance, second metadata pertaining to one or more associations between local datasets of the second subset of members and the one or more data schema objects;
create one or more schema data bindings in the central database in accordance with the second metadata;
receive, from an individual or entity associated with the federated learning alliance, third metadata pertaining to a proposed training dataset for solving a machine learning task, the third metadata specifying the one or more data schema objects;
create a training dataset object in the central database in accordance with the third metadata; and
initiate, based on the training dataset object, training of a machine learning model via federated learning, wherein the training is executed by at least a portion of the second subset of members using their respective local datasets.

16. The computer system of claim 15 wherein the one or more schema data bindings include connection information for connecting to the local datasets but do not include data samples of the local datasets.

17. The computer system of claim 15 wherein the one or more proposed data schemas comprise heterogenous data schemas with different feature sets, but at least one common feature.

18. The computer system of claim 17 wherein the third metadata includes an identification of the at least one common feature as a join column for the training dataset.

19. The computer system of claim 15 wherein the program code further causes the processor to, prior to initiating the training of the machine learning model:
receive, from each of the second subset of members, an indication of whether said each member wishes to participate in the training using its local dataset; and
mark, based on the received indications, a subset of the one or more schema data bindings as being available for the training.

20. The computer system of claim 19 wherein the program code further causes the processor to, prior to initiating the training of the machine learning model:
receive, from the individual or entity, a selected portion of the subset of the one or more scheme data bindings that will participate in the training; and
create a training configuration object in the central database that specifies the selected portion.

21. The computer system of claim 20 wherein the portion of the second subset of members that execute the training of the machine learning model are members with local datasets included in the selected portion of the subset of the one or more scheme data bindings.
